(19) United States
(12) Patent Application Publication
(10) Pub. No.: US 2010/0153233 A1
(43) Pub. Date: Jun. 17, 2010

(54) SYSTEM AND METHOD FOR SHOPPING

(75) Inventors: Seong-Kook Shin, Seoul (KR); Sang-Kwon Lee, Suwon-si (KR); Hyok-Sung Choi, Seoul (KR); Se-Jun Han, Daejeon (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/531,932

(22) PCT Filed: Mar. 18, 2008
(86) PCT No.: PCT/KR08/01525

§ 371 Date: Jan. 6, 2010

(30) Foreign Application Priority Data
Mar. 19, 2007 (KR) 10-2007-0026715
Feb. 26, 2008 (KR) 10-2008-0017495

(51) Int. Cl. G06Q 30/00; G06F 3/00

(52) U.S. Cl. 705/27; 715/741; 715/733; 715/744

(57) ABSTRACT

Provided are a system and method for shopping, and more particularly, a system and method for shopping, in which a display device transmits control authority to a content-providing device connected by a predetermined communication network, and the content-providing device receives the control authority, configures a screen, which includes at least a piece of content, according to the received control authority and the results of a service request, and provides the configured screen to the display device so that the configured screen can be displayed on the display device.

### TECHNICAL FIELD

The present invention relates to a system and method for shopping, and more particularly, to a system and a method for shopping, in which a display device transmits control authority for screen display thereof to a content-providing device, and the content-providing device receives the control authority and configures a screen, which includes at least a piece of content, according to the received control authority and based on any one of screen resolution and print resolution of the display device so that the configured screen can be displayed on the display device.

### BACKGROUND ART

With the advancement of the Internet, a wide variety of Internet sites offering diverse commercial products and services have been developed and are widely used. Since Internet sites are loaded on Internet servers, a user may access the servers through the Internet using a terminal device having a built-in Web browser (that is, a communication device such as a personal computer or a mobile phone) to display the sites on the monitor of the terminal device.

In this case, the Internet server includes a database storing various data, and the Internet site includes various link buttons to the database. Therefore, after accessing the Internet server, i.e., the Internet site, the user may move to another site by clicking on one of the link buttons, browse information, or download data stored in the database as desired.

In recent years, business-to-business (B2B) or business-to-consumer (B2C) transactions through Internet sites have become wide spread. In particular, vendors can now provide an order system and a payment system on Internet sites as well as detailed information of their products. Therefore, consumers accessing the Internet sites can be provided with product information and purchase and pay for the products from the same site. Meanwhile, transactions conducted through such Internet sites has expanded from selling general goods to selling insurance, travel products, and making reservations. That is, consumers can now be provided with various services through the Internet, in addition to durable products.

However, as consumer preferences are diverse, it is becoming increasingly difficult to select suitable products and services based only on the information provided on the Internet sites. That is, while consumers want to obtain more detailed information about products and services that they wish to purchase, most Internet sites only provide general description of products and services. Thus, it is difficult for the consumers to obtain sufficient information about the products of their interests to make and informed decision on the purchase. In particular, discrepancies between general description and consumer expectations are often found in insurance and travel products.

Korean Patent Publication No. 2001-0077585, entitled “Consumer Consultation System for Electronic Commerce and Method of Operating the System,” provides a consultation system to consumers in electronic commerce. When a consumer who has accessed a vendor site through the Internet seeks consultation about a product, the system can enable the consumer to easily consult with a product consultant connected to an Internet phone while viewing the same screen as the product consultant.

Korean Patent Publication No. 2002-0023695, entitled “Method of Browsing Shopping Products through Web Screen Sharing and System for Exchanging Shopping Information,” discloses a system and method for accessing the same electronic commerce server from different locations using a function of sharing a Web browser screen, browsing products and exchanging shopping information, and purchasing products.

According to these conventional technologies, a consumer and a product consultant can exchange shopping information while viewing the same screen, and the consumer can purchase a product based on the consultation. However, in the conventional technologies, the screen displayed on a display device cannot provide shopping information based on the consumer's request and in a screen display format suitable for the display device.

### DISCLOSURE OF INVENTION

### Technical Problem

Aspects of the present invention provide a system and method for shopping for shopping, in which control authority for a service request irrelevant to a screen being displayed is transmitted to a content-providing device via a predetermined communication network, and the content-providing device authenticates the service request so that a user and a shopping assistant can exchange information in real time.

Aspect of the present invention also provide a system and method for shopping, in which a shopping assistant configures a screen, which includes at least a piece of content, based on obtained information, using a content-providing device and at least one of screen resolution and print resolution of a display device and according to the results of a service request, and transmits the configured screen to the display device so that the configured screen can be displayed on the display device.

However, aspects of the present invention are not restricted to the one set forth herein. The above and other aspects of the present invention will become more apparent to one of ordinary skill in the art to which the present invention pertains by referencing the detailed description of the present invention given below.

### Technical Solution

According to an aspect of the present invention, there is provided a display device including a display module that displays content; an information-storage module that stores information of a device that displays user information and the content; a content-request request module that transmits the service request of the user for the content to a content-providing device along with the information stored in the information-storage module; and a content-receiving module that receives content corresponding to the service request.

According to another aspect of the present invention, there is provided a content-providing device including an authentication module that performs authentication for the display unit that receives the provided content and the user that views the content; a control module that generates identification information for a service request corresponding to the content transmitted from the display device, and manages the service state information for the identification information; and a content-reconfiguration module that the screen of the display device based on the control command of the shopping assistant that has registered the content for the service request.

According to another aspect of the present invention, there is provided a method of operating a display device including displaying content; transmitting the service request of the user for the content along with the user information and information of a device that displays the content to the content-providing device; and receiving content corresponding to the service request

According to another aspect of the present invention, there is provided a method of operating a content-providing device including performing authentication for a display device that receives provided content and a usr that performs authentication for a user that views the content; generating identification for a service request corresponding to the content transmitted from the display device, and managing service state information for the identification information; and reconfiguring the screen of the display device based on the control command of a shopping assistant that has registered the content for the service request.

The above and other aspects and features of the present invention will become more apparent by describing in detail exemplary embodiments thereof with reference to the attached drawings, in which:

### BRIEF DESCRIPTION OF THE DRAWINGS

FIG. 1 illustrates a shopping system according to an exemplary embodiment of the present invention;

FIG. 2 is a block diagram of a display device shown in FIG. 1;

FIG. 3 is a block diagram of a content providing device shown in FIG. 1;

FIG. 4 illustrates a method of operating a shopping system according to an exemplary embodiment of the present invention;

FIG. 5 is a flowchart illustrating the method of providing a service according to an exemplary embodiment of the present invention; and

FIG. 6 illustrates the method of canceling the service request according to an exemplary embodiment of the present invention.

### MODE FOR THE INVENTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

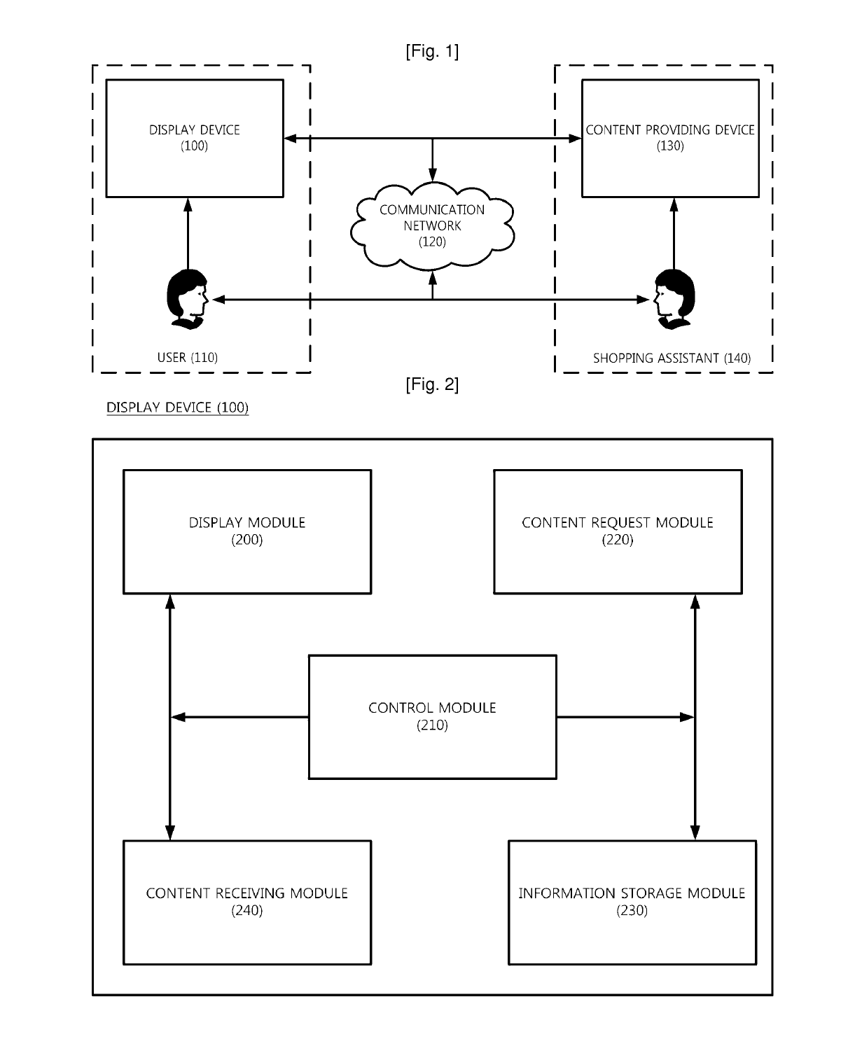

FIG. 1 illustrates a shopping system according to an exemplary embodiment of the present invention.

Referring to FIG. 1, the shopping system may include a display device 100 and a remote content-providing device 130 connected by a communication network 120.

The display device 100 receives content from a head end (not shown), which transmits at least one of conventional terrestrial, satellite and cable broadcasts, and displays the received content on a screen thereof. The display device 100 may include a communication interface used to request the content-providing device 130 to provide a service.

Also, the display device is provided content related to the content transmitted from the head end from the content-providing device 130, and displays the content. In the embodiments of the present invention, content transmitted from the head end is called “first content”, and content related with the content transmitted from the head end is called “second content.”

The user can request the first content or the second content displayed through the display device 100 to the content-providing device 130 through a button installed in the display device 100. Here, the user can input user information and the information about the display device when requesting a service, and the user information and display device information can be transmitted to the content-providing device in advance so that the information is not separately inputted when requesting the service.

In order to request the content-providing device 130 to provide a service, a user 110 may input a control command to the display device 100 using an input module (not shown, for example, a remote control) that the user has. Accordingly, the display device 100 may transmit display device information and user information to the content-providing device 130 via the communication network 120.

The communication network 120, which connects the display device 100 and the content-providing device 130, may be any one of a conventional wired or wireless Internet network, a power line communication network, and a mobile communication network.

Using the communication network 120 described above, the display device 100 transmits the display device information, the user information and content information to the content-providing device 130. By transmitting the display device information and the user information, the display device 100 transfers control authority for its screen display to the content-providing device 130. The content-providing device 130 receives the display device information and the user information, configures a screen, which includes at least a piece of content, according to the received control authority, and provides the configured screen to the display device 100 so that the screen can be displayed on the display device 100. Here, the user information can include the user name, the phone number, etc., and the display device information can include the model name, version, resolution, CODEC, storage medium, etc.

Further, if a service request is transmitted from the display device 100, the content-providing device 130 can generate unique identification information (hereinafter, called “service-request ID”) for the transmitted service request. The service-request ID can be uniquely generated according to the service request from the user. Further, the content-providing device can manage the service state information for the user's service request. Here, the service state information refers to the progressing state of the service for the user's service request, and the service state information can include “service request state”, “service waiting state” and “service connection state”, but the present invention is not limited to the examples.

To this end, the content-providing device 130 authenticates the display 100 and the user 110. The content-providing device 130 may receive authentication information from a reliable authentication authority (not shown) as a way to authenticate the display device 100 and the user 110.

After the display device 100 and the user 110 are authenticated, the service-request ID corresponding to the user's 100 service request, content information corresponding to the user's service request, the display device information and the user information are provided to a shopping assistant 140 through the content-providing device 130 or a device (such as a personal computer (PC)) used by the shopping assistant 140.

After obtaining the display device information and the user information, the shopping assistant 140 attempts to contact the user 110 using any one of a public switched telephone network (PSTN), a voice over Internet protocol (VoIP), and a text message. Here, if the shopping assistant 140 has received a request of another user before the user's request, the shopping assistant 140 transmits the remaining waiting time to the content-providing device 130, and the content-providing device 130 transmits the transmitting waiting time information to the display device 100 and changes the service state information to “service waiting state.” Here, the display device 100 displays the transmitted waiting time information, so the user can confirm the remaining time until the user 110 is connected to the shopping assistant 140.

After the abovementioned waiting time passes by, the shopping assistant 140 tries to connect to the user 110 based on the information transmitted from the content-providing device 130. The embodiment of the present invention illustrates a case where the content-providing device 130 transmits a service-request ID, user information, display device information, and content information together, but the present invention is not limited to the case. Further, the content-providing device 130 can transmit only the service-request ID to the shopping assistant 140, and the shopping assistant 140 can request the user information and display device information to try to connect to the user 110 and connect to the display device 100 of the user 110, but the present invention is not limited to the case.

Further, unless the shopping assistant 140 has received a service request from another user before the service request of the user 110, the shopping assistant 140 tries to connect to the user 100 through the abovementioned various methods. Such a connection attempt is designed to exchange information regarding a service request with the user 110 in real time, and the shopping assistant 140 is required to contact the user 110.

For example, while watching a clothing sales program broadcast on the display device 100, if the user 110 desires to obtain information regarding how to wear specific clothes that are being broadcast, the user 110 inputs a control command for a service request to the display device 100 through an input module. In this case, the user 110 may input the control command to the display device 100 by pressing a preset shortcut key on the input module.

The service request may be made regardless of a screen displayed on the display device 100.

The display device 100 receives the control command for the service request and provides the display device information and the user information to the content-providing device 130. Then, the content-providing device 130 receives the display device information and the user information and performs an authentication procedure with reference to the display device information and the user information. According to the authentication result of the content-providing device 130, a new service-request ID is generated, user information, display device information and content information are transmitted to the shopping assistant 140 along with the generated service-request ID, so information can be exchanged between the shopping assistant 140 and the user 110.

The shopping assistant 140 obtains information regarding the service request after the information exchange with the user 110, the shopping assistant 140 tries to connect to the user 110. If connected to the user 110, the shopping assistant remotely controls the screen display of the display device 110 based on the obtained information and using the control authority obtained from the display device 100 through the content-providing device 130. Here, the content-providing device 130 can change the service state information to “service connection state.”

The content-providing device 130 configures a screen, which includes at least a piece of content about a customized method of wearing the clothes for the user 110, with reference to the user information and the display device information (e.g., model name, version, screen resolution, CODEC, and storage medium) according to the control authority and transmits the configured screen to the display device 100.

The display device information transmitted by the display device 100 in order to facilitate information exchange between the shopping assistant 140 and the user 110 may contain predetermined information (for example, channel information) regarding a broadcast being displayed on the display device 100. However, the present invention is not limited thereto.

If a service relevant to a screen being displayed on the display device 100 is requested, channel information of the screen may be contained in the display device information. On the other hand, if a service irrelevant to the screen being displayed on the display device 100 is requested, the service request may be for a service that the content-providing device 130 previously registered with a service request shortcut key by the user 110.

Further, if the user 110 intends to cancel the service request after receiving the service through the service request, the cancel is requested by a remote-control device or the button of the display device 100, and the display device 100 can transmit the cancellation of the service request to the content-providing device 130. The content-providing device 130 deletes the service-request ID of the corresponding user 100 according to the transmitted service-request cancellation, and transmits the cancellation to the shopping assistant 140. Further, the content-providing apparatus 130 deletes the service state information for the service-request ID according to the service-request cancellation.

FIG. 2 is a block diagram of the display device 100 shown in FIG. 1.

Referring to FIG. 2, the display device 100 includes a display module 200, a control module 210, a content request module 220, an information storage module 230, and a content reception module 240.

First of all, the display module 200 is a module that displays general content. The display module 200 displays a screen which includes at least a piece of content according to control authority for the display device 100 transmitted from a head end or the content-providing device 130. That is, the display module 200 can display at least one of the first content or the second content.

Since the shopping assistant 140 has the control authority for the screen display of the display device 100 when there is a service request, the display module 200 can also display a screen controlled by the shopping assistant 140 who has exchanged information with the user 110. That is, by exchanging information with the shopping assistant 140, the user 110 can view a screen displayed in response to the service request of the user 110.

The control module 210 receives a service request signal from an input module (not shown) such as a remote-control device or a button installed in the display device 100, and transmits control signals to the information storage module 230 and the content request module 220 so that the display device information and the user information stored in the information storage module 230 can be transmitted via the content request module 220. Here, the present embodiment illustrates a case where display device information and user information has been stored in the information-storage module 230 in advance, but the present invention is not limited to this case. It is possible for the user 110 to input user information when requesting a service, and it is possible for the display device information to be made when a service is requested, but the present invention is not limited to these cases.

That is, the content request module 220 transmits the display device information and the user information stored in the information storage module 230 along with content information corresponding to the service request of the user 110 to the content-providing device 130 via the communication network 120. In this case, information regarding a screen displayed on the display module 200, that is content information, is also transmitted to the content-providing device 130. The screen information of the display module 200 may be channel information displayed on the display module 200 that the control module 210 referred to when receiving the service request signal.

The content reception module 240 receives a screen which includes at least a piece of content and which is configured based on information sent by the content request module 220 and according to the control authority for the display device 100.

In this case, screens received by the content reception module 240 are generated by the content-providing device 130 based on at least one of model name, version, screen resolution, printing resolution, CODEC and storage medium, which have been received from the content request module 220, and according to the results of service requests of the user 110. These screens are displayed on the display module 200.

The display device 100 according to the present embodiment transmits control authority for the display of a screen corresponding to a service request of the user 110 to the content-providing device 130 via the content request module 220 and receives and displays a screen which includes at least a piece of content generated by the content-providing device 130 according to the results of the service request of the user 110 and based on information exchanged between the user 110 and the shopping assistant 140. Here, such methods as PSTN, VoIP and text message can be used for information exchange between the user 110 and the shopping assistant 140, but the present invention is not limited to these methods.

Accordingly, the user 110 using the display device 100 can receive the requested service, that is, view the screen which includes at least a piece of content generated by the content-providing device 130 according to the results of the service request of the user 110 and which is displayed according to the control authority.

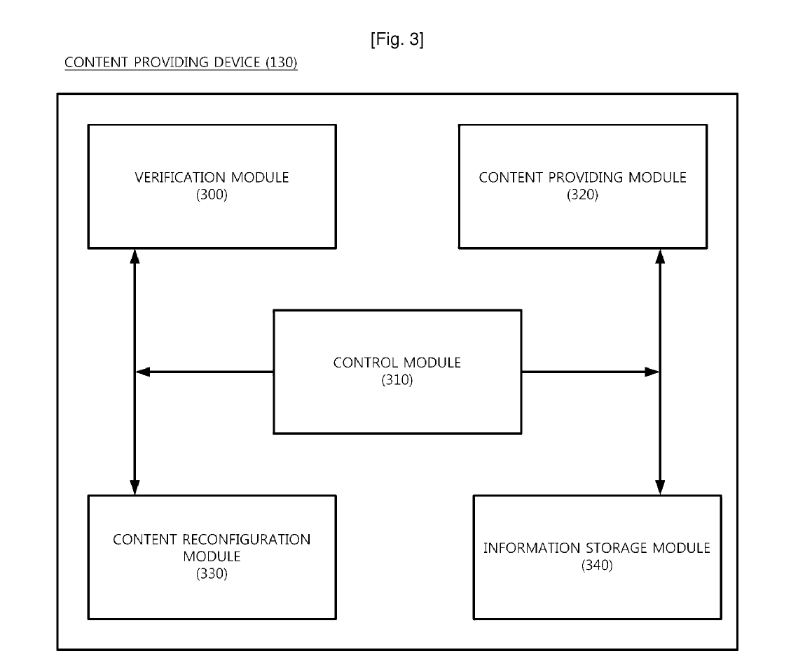

FIG. 3 is a block diagram of the content-providing device 130 shown in FIG. 1.

The content-providing device 130 configures a screen, which includes at least a piece of content, according to control authority received from the display device 100 and provides the configured screen to the display device 100.

Referring to FIG. 3, the content-providing device 130 includes an authentication module 300, a control module 310, a content provision module 320, a content reconfiguration module 330, and an information storage module 340.

The authentication module 300 performs a predetermined authentication procedure based on display device information and user information received through the content provision module 320. The authentication module 300 may receive authentication information from a reliable authentication authority (not shown) connected by the communication network 120 as a way to perform the authentication procedure.

That is, when requested to authenticate the display device 100 and the user 110, the authentication module 300 performs the authentication procedure and transmits its authentication results to the display device 100 or the control module 310.

The control module 310 controls the information storage module 340 to store the authenticated display device information and the authenticated user information and provide the authenticated user information to the shopping assistant 140. Further, the control module 310 generates a unique service-request ID corresponding to user information, display device information and content information for the service request transmitted from the display device 100, and manages the service state information for the generated service-request ID. That is, the control module 310 can manage the service state information for the generated service-request ID as “service request state”, “service waiting state” and “service connection state.”

The user information provided to the shopping assistant 140 is referred to by the shopping assistant 140 in order to exchange information with the user 110 and may vary according to a communication network used for the information exchange.

For example, if the shopping assistant 140 and the user 110 exchange information using a PSTN, the user information may generally include a wired phone number of the user 110.

When connection between the shopping assistant 140 and the user 110 is completed, the control module 310 can change the service state information for the service request ID to “service connection state.” Further, if the shopping assistant 140 has already received a service request from another user, the shopping assistant 140 transmits the waiting time information to the content-providing device 100, and the content-providing device 130 transmits the transmitted waiting time information to the display device 100 so that the user can check the waiting time information, and at the same time, the service state information for the service-request ID can be changed to “service waiting state.”

As a result of receiving the above information, the content-providing device 130 or the shopping assistant 140 using the content-providing device 130 obtains control authority for the screen display of the display device 100. In this case, the control authority is used to control the screen display of the display device 100, that is, display a screen, which includes at least a piece of content of a 1:1 actual size, based on model name, version, screen resolution, printing resolution, CODEC and storage medium of the display device 100.

The shopping assistant 140, who has obtained the user information, attempts to exchange information with the user 110 with reference to the user information. Since the information exchange between the shopping assistant 140 and the user 110 has been described above with reference to FIGS. 1 and 2, a detailed description thereof will be omitted here. However, it should be noted that the information exchanged between the shopping assistant 140 and the user 110 may vary according to an information exchange method used.

The control module 310 controls the information storage module 340 to provide the display device information to the content reconfiguration module 330 in response to a content reconfiguration command issued by the shopping assistant 140 who has obtained information regarding a service request from the user 110.

The content reconfiguration module 330 configures a screen, which includes at least a piece of content, according to the control authority and using the display device information stored in the information storage module 340. The display device information used here includes at least one of screen resolution and print resolution and may further include channel information of a broadcast in relation to which the service request has been made.

The content reconfiguration module 330 may configure a screen including at least a piece of content or specific content requested by the user 110.

The content reconfigured by the content reconfiguration module 330 is transmitted to the display device 100 via the content provision module 320.

The content-providing device 130 according to the present embodiment configures a screen, which includes at least a piece of content, based on at least one of the model name, version, screen resolution, printing resolution, CODEC, and storage medium of the display device 100 and according to control authority received from the display device 100 and provides the configured screen to the display device 100.

Further, if the user 110 intends to cancel the service request after receiving the service through the service request, the cancel is requested by a remote-control device or the button of the display device 100, and the display device 100 can transmit the cancellation of the service request to the content-providing device 130. The content-providing device 130 deletes the service-request ID of the corresponding user 100 according to the transmitted service-request cancellation, and transmits the cancellation to the shopping assistant 140. Further, the content-providing apparatus 130 deletes the service state information for the service-request ID according to the service-request cancellation.

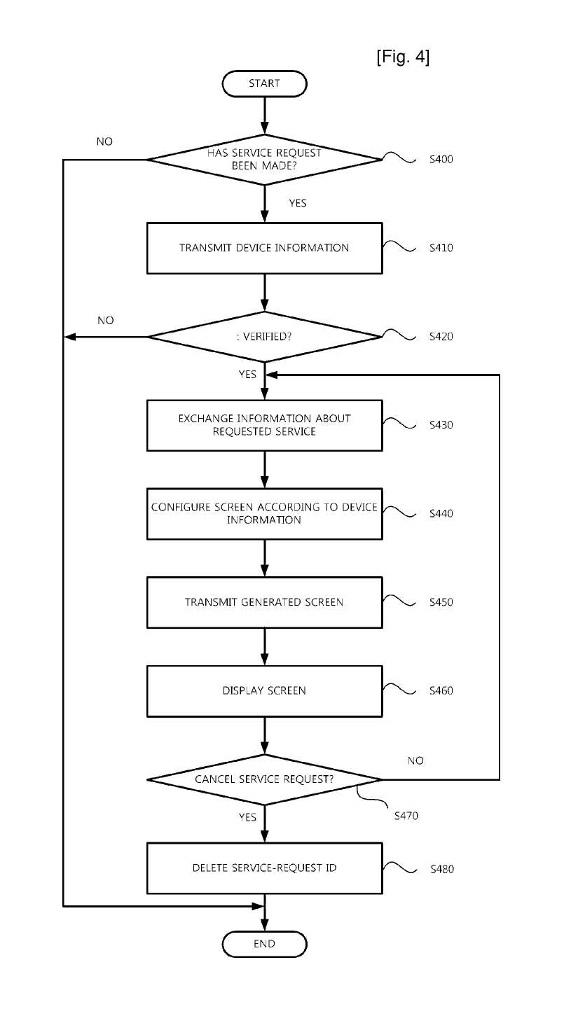

FIG. 4 illustrates a method of operating a shopping system according to an exemplary embodiment of the present invention.

Here, FIG. 4 can be understood that the operation is performed between the display device 100 and the content-providing device 130 connected by the communication network 120.

In addition, the user 111 and the shipping assistant 140, who has control authority for the screen display of the display device 100, exchange information in real time.

Referring to FIG. 4, the control module 210 of the display device 100 determines whether a control signal for a service request has been input from an input module such as a remote control (operation S400). Such a service request can be made by requesting a service for the desired content through an input means such as a remote control device while the user 110 views the first content or the second content through the display device 100.

A service request may be input using a remote control provided by a display device manufacturer (not shown) or a preset shortcut key for the content-providing device 130.

Further, in operation S400 in which it is determined whether a service request has been made, the user 110 may request a service irrelevant to a screen being displayed on the display module 200.

According to the determination result of the control module 210, display device information and user information stored in the information storage module 230 are transmitted to the content-providing device 130 via the content request module 220 (operation S410). Here, the content request module 220 can transmit the display device information and user information along with content information corresponding to the service request of the user 110.

In operation S400 in which a service request is made, if a service relevant to a screen being displayed on the display device 100 is requested, channel information of the screen is also transmitted to the content-providing device 130 in operation S410 in which control authority is transmitted. On the other hand, if a service irrelevant to the screen being displayed on the display device 100 is requested, the service request may be for a display screen (channel) that the content-providing device 130 preset by the user 110 provides.

When the display device information and the user information are transmitted to the content-providing device 130, the control authority for the display device 100 is transferred to the content-providing device 130. The control authority denotes authority to control a screen displayed on the display module 200 of the display device 100.

If the control authority is transmitted to the content-providing device 130 in operation S410, the content-providing device 130 performs an authentication procedure based on the display device information and the user information (operation S420). Here, if the authentication process is completed, the control module 310 of the content-providing device 130 generates a unique service-request ID for the service request of the user 110, manages the service state information for the generated service-request ID, and changes the service state information to “service request state” if a service is requested.

Using the user information received according to the authentication result, the shopping assistant 140 exchanges information regarding the service request with the user 110 (operation S430). Here, the information exchange between the shopping assistant 140 and the user 110 can be achieved as the content-providing device 130 transmits the service request of the user to the shopping assistant 140. Specifically, the content-providing device 130 transmits the service-request ID, user information, display device information and content information to the shopping assistant 140, and the shopping assistant can try to be connected to the usr 110 based on the information transmitted when trying to connect to the user 110. Here, if the shopping assistant has received a service request from another user before the service request of the user 110, the shopping assistant 140 transmits the remaining waiting time information to the content-providing device 130, and the content-providing device 130 transmits the waiting time information to the display device 100 so that the user can check when the shopping assistant will try to connect to him. Further, when transmitting the waiting time information, the content-providing device 130 can change the service state information for the service-request ID to “service waiting state.” Further, after the waiting time passes by, the shopping assistant 140 tries to connect to the user 110 based on the transmitted information. Here, the information exchange between the shopping assistant 140 and the user 110 is made using any one of a PSTN, a VoIP, and a text message. As a result of the information exchange, the shopping assistant 140 obtains the information regarding the service request. Here, the control module of the content-providing device 130 can change the state information for the service-request ID to “service connection state” when exchange information between the shopping assistant 140 and the user 110.

After obtaining the information regarding the service request, the shopping assistant 140 configures a screen, which can be displayed on the display device 100, based on the obtained information and using the content reconfiguration module 330 of the content-providing device 130 (operation S440). In operation S440, the obtained information can be understood to have been requested through the information exchange between the shopping assistant 140 and the user 110.

In operation S440, the content reconfiguration module 330 configures a screen, which includes at least a piece of content, with reference to the display device information stored in the information storage module 340 of the content-providing device 130. After the content reconfiguration module 330 configures the screen in operation S440, the screen is transmitted to the remote display device 100, which is connected to the content-providing device 130 by the communication network 120, via the content provision module 320 (operation S450).

Then, the content reception module 240 of the display device 100 receives the screen through the communication network 120 and displays the received screen on the display module 200 (operation S460).

That is, control authority mentioned above in the exemplary embodiments of the present invention is used to configure a screen according to the results of a service request of the user 110 and replace a screen being displayed on the display device 100 with the configured screen.

For example, while the display device 100 is displaying at least one of general cable broadcasts, if it receives screens configured according to the results of a service request of the user 110, the control authority is used to control the display device 100 to display at least one of the screens configured by a cable broadcasting station or the content-providing device 130.

Further, if the user 110 receives the desired service through information exchange with the shopping assistant 140, the user 110 cancels the service request through the abovementioned input module S470.

When the user cancels the service request, the control module 310 deletes the service-request ID S480. Further, the control module 310 transmits the cancellation of the service request to the shopping assistant 140, and deletes the service state information for the service-request ID according to the cancellation of the service request.

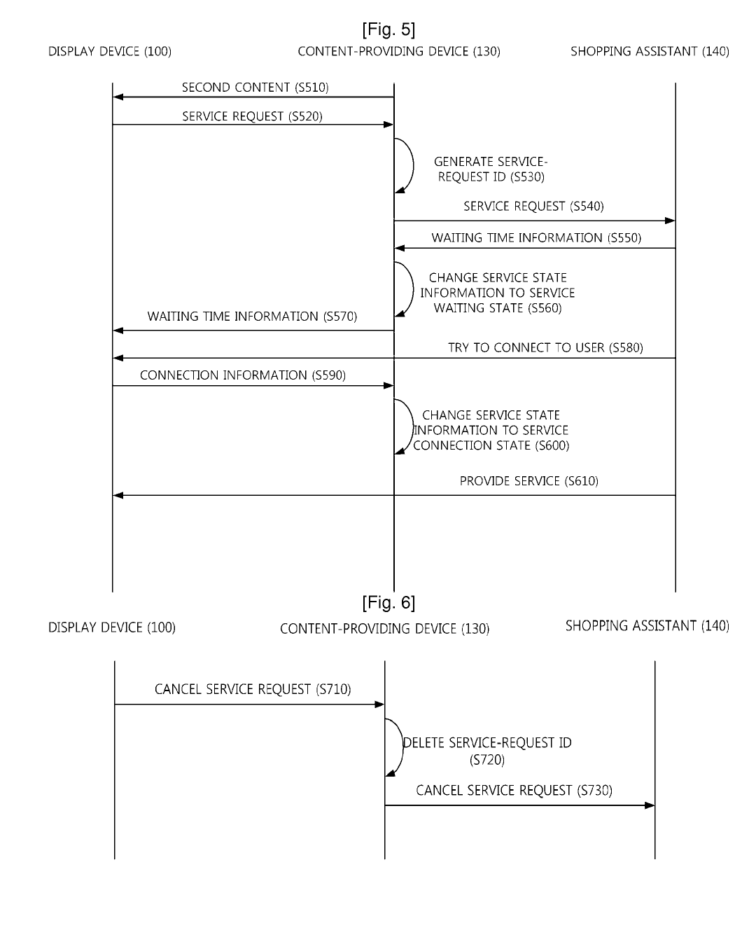

FIG. 5 illustrates a method of providing a service according to an exemplary embodiment of the present invention.
As illustrated, the content-providing device 130 provides the second content related with the first content displayed in the display device 100 registered by the shopping assistant 140 to the display device 100 S510. If the user checks the second content displayed in the display device 100, the display device 100 transmits the service request of the user to the content-providing device 130 S520. Here, when the service of the user is requested, the user information, display device information, and content information can be transmitted together.

The content-providing device 130 generates the service-request ID corresponding to the service request transmitted from the display device 100, and manages the service state information for the generated service-request ID S530. Here, the service state information at the time of generating the service-request ID can be in “service request state.”

The content-providing device 130 transmits the service request transmitted from the display device 100 to the shopping assistant 140 S540. Here, the content-providing device 130 can transmit user information, display device information and content information together. If the shopping assistant 140 cannot promptly try to connect to the user 110, the shopping assistant 140 transmits the waiting time information to the content-providing device 130 S550.

When the waiting time information is transmitted form the shopping assistant 140, the content-providing device 130 changes the service state information to “service waiting state” S560, and transmits the waiting time information to the display device 100 S570. Hence, the user 110 can expect the waiting time.

If it becomes possible for the shopping assistant 140 to try to connect to the user 110, the shopping assistant 140 tries to connect to the user 110 through user information and display device information transmitted together when the service request is requested S580.

If the user 110 and the shopping assistant 140 are connected, the display device transmits the connection information to the content-providing device 130 S590, and the content-providing device 130 changes the service state information to “service connection state” S600.

Then, the shopping assistant 140 provides the service desired by the user based on the screen control authority of the display device 100 transmitted from the content-providing device 13 through information exchange with the user 110 S610.

Here, in FIG. 5, in the case where the shopping assistant 140 can be promptly connected to the user 110 in response to the service request transmitted from the content-providing device 130, operations S550 to S570 can be omitted.

FIG. 6 illustrates a method of canceling a service request according to an exemplary embodiment of the present invention.

As illustrated, in the case where the user 110 has received a desired service, and does not want to receive the service any more, the user inputs cancellation of the service request through the abovementioned input module, and the display device 100 transmits cancellation of the service request to the content-providing device 130 S710.

The content-providing device 130 deletes the generated service-request ID S720, and transmits cancellation of the service-request transmitted from the display device 100 to the shopping assistant 110 so that the shopping assistant 140 does not provide the service any more S730.

According to the system and method for shopping, a user can received a desired service without directly controlling the screen or using a multi-step menu, which is advantageous.

Also, according to the system and method for shopping, the results for the service requests can be provided by requested display devices in real time, which is advantageous.

The above described exemplary embodiments are for purposes of illustration only, and are not to be construed as a limitation of the invention. The scope of the invention is given by the appended claims, rather than the preceding description, and all variations and equivalents which fall within the range of the claims are intended to be embraced therein.

### INDUSTRIAL APPLICABILITY

A system and method for shopping according to the present invention can enable a user to receive a desired service without controlling a screen in person or using a multi-level menu.

In addition, the results of each service request can be provided in real time to each corresponding display device that has made the service request.

1. A display device comprising:
a display module that displays content;
an information-storage module that stores information of a device that displays user information and the content;
a content-request module that transmits the service request of the user for the content to a content-providing device along with the information stored in the information-storage module; and
a content-receiving module that receives content corresponding to the service request.

2. The display device of claim 1, wherein the content-request module provides the screen-control authority of the display module to the content-providing device.

3. The display device of claim 1, wherein the user information includes at least the user name, phone number, and address of the user.

4. The display device of claim 1, wherein the display device information includes the model name, version, screen resolution, printing resolution, CODEC and storage medium of the display device.

5. A content-providing device comprising:
an authentication module that performs authentication for the display unit that receives the provided content and the user that views the content;
a control module that generates identification information for a service request corresponding to the content transmitted from the display device, and manages the service state information for the identification information; and
a content-reconfiguration module that the screen of the display device based on the control command of the shopping assistant that has registered the content for the service request.

6. The device of claim 5, wherein the authentication module performs authentication through the user information transmitted from the display device and the display device information.

7. The device of claim 6, wherein the control module transmits the identification information, the user information, the display device information, and content information corresponding to the service request to the shopping assistant.

8. The device of claim 7, wherein the shopping assistant tries to connect to the user based on the transmitted information.

9. The device of claim 8, wherein the shopping assistant transmits the waiting time information to be waited until a connection is tried, and the control module transmits the waiting time information to the display device.

10. The device of claim 8, wherein the shopping assistant reconfigures the screen of the display device by controlling the content-reconfiguration module based on the information exchanged with the user when connected to the user.

11. The device of claim 5, wherein if cancellation of the service request is transmitted from the display device, the control module deletes the deleted identification information, and transmits the cancellation of the service request to the shopping assistant.

12. A method of operating a display device, the method comprising:
displaying content;
transmitting the service request of the user for the content along with the user information and information of a device that displays the content to the content-providing device; and
receiving content corresponding to the service request.

13. The method of claim 12, wherein the transmitting of the service request to the content-providing device includes transmitting the screen-control authority that displays the content.

14. The method of claim 12, wherein the user information includes at least one of the user name, phone number and address of the user.

15. The method of claim 12, wherein the display device information includes at least one of the model name, version, screen resolution, printing resolution, CODEC and storage medium of the display device.

16. A method of operating a content-providing device, the method comprising:
performing authentication for a display device that receives provided content and
a user that performs authentication for a user that views the content;
generating identification for a service request corresponding to the content transmitted from the display device, and managing service state information for the identification information; and
reconfiguring the screen of the display device based on the control command of a shopping assistant that has registered the content for the service request.

17. The method of claim 16, wherein the performing of the authentication includes performing authentication through the user information transmitted from the display device and the display device information, and obtaining the screen control authority of the display device.

18. The method of claim 17, wherein the managing of the service state information includes transmitting the identification information, the user information, the display device information and content information corresponding to the service request to the shopping assistant.

19. The method of claim 18, wherein the shopping assistant tries to connect to the user based on the transmitted information.

20. The method of claim 19, wherein the step of trying to connect to the user includes transmitting waiting time information to be waited until there is a try for connection, and transmitting the waiting time information to the display device.

21. The method of claim 19, wherein the step of trying to connect to the user includes reconfiguring the screen of the display device based on the information exchanged with the user when connected to the user.

22. The method of claim 16, further comprising:
receiving cancellation of the service request of the user; and
removing the generated identification information according to the cancellation of the service request, and transmitting the cancellation of the service request to the shopping assistant.
